(19) United States
(12) Patent Application Publication
(10) Pub. No.: US 2012/0163661 A1
(43) Pub. Date: Jun. 28, 2012

(54) APPARATUS AND METHOD FOR RECOGNIZING MULTI-USER INTERACTIONS

(75) Inventors: Junsup LEE, Daejeon (KR); Seokbin KANG, Daejeon (KR); Soo Young KIM, Daejeon (KR); Jae Sang YOO, Daejeon (KR); Junsuk LEE, Daejeon (KR)

(73) Assignee: Electronics and Telecommunications Research Institute, Daejeon (KR)

(21) Appl. No.: 13/335,353

(22) Filed: Dec. 22, 2011

(30) Foreign Application Priority Data
Dec. 23, 2010 (KR) 10-2010-0133771

(51) Int. Cl. G06K 9/00

(52) U.S. Cl. 382/103

(57) ABSTRACT

An apparatus for recognizing multi-user interactions includes: a pre-processing unit for receiving a single visible light image to perform pre-processing; a motion region detecting unit for detecting a motion region from the image to generate motion blob information; a skin region detecting unit for extracting information on a skin color region from the image to generate a skin blob list; a Haar-like detecting unit for performing Haar-like face and eye detection by using only contrast information from the image; a face tracking unit for recognizing a face of a user from the image by using the skin blob list and results of the Haar-like face and eye detection; and a hand tracking unit for recognizing a hand region of the user from the image.

### CROSS-REFERENCE(S) TO RELATED APPLICATION(S)

The present invention claims priority of Korean Patent Application No. 10-2010-0133771, filed on Dec. 23, 2010, which is incorporated herein by reference.

### FIELD OF THE INVENTION

The present invention relates to a recognition of interactions of multiple users, and more particularly, to an apparatus and method for recognizing multi-user interactions, which are capable of exactly recognizing multi-users by using an asynchronous vision processing even when a single visible light image is inputted.

### BACKGROUND OF THE INVENTION

In general, in existing interaction systems, there are largely two approaches for tracking a user and recognizing hands and feet.

The first approach is a method of tracking the position of a user and the gestures of hands, feet or the like of the user by allowing the user to use a special hardware or device. Among others, the most common method enables a user to directly point a screen by using a special controller (e.g., Nintendo's Wii Remote) equipped with an infrared camera. Also, there is a method of recognizing interaction of a user by letting the user wear a special reflector, paint or a vision recognizing object (gloves, shoes, hat and the like) in monochrome or with special pattern and then by tracking the corresponding vision recognizing object. Most contemporary motion capture equipments employ this method. Such hardware equipment has a drawback that a user must wear an electronic equipment or a special object designed for interaction.

The second approach is a method of photographing a user by using a special camera and then recognizing interaction of the user. In this method, 3D depth information is extracted from a user space by using an infrared time of flight (TOF) camera and the user and background are separated based on the extracted 3D depth information, and a gesture recognizing point of the user is extracted and tracked to recognize the interaction of the user. Alternatively, there is a method of combining two visible light cameras well to receive a stereo image input and to generate 3D depth information based on the difference between feature points of two images, thereby recognizing interaction of a user in the same way as the TOF camera. This interaction recognizing system using a special camera has drawbacks that the special camera is very expensive to use in general home and that the special camera must be utilized in order to recognize interaction of a user.

To overcome the drawbacks of the two approaches, it is important to recognize gesture interaction of a user through an image input equipment that can be easily accessed by the user and data format supported by most image input equipments, without requiring the user to wear any additional object and without a special background environment.

However, in cheap image input equipments, such as a webcam or the like, which provides a single image input, a low resolution image is inputted and information for recognizing a user is very insufficient, so that the precision for recognition is remarkably deteriorated, or computation amount is massive, resulting in very poor real time performance.

### SUMMARY OF THE INVENTION

In view of the above, the present invention provides an apparatus and method for recognizing multi-user interactions by using an asynchronous vision processing, which simultaneously produce data through various types of vision processes in a non-object extraction-based single webcam image, and exactly recognize multi-user even in a single visible light image by effectively recognizing face of the multi-user through complex relation setting and multiple computing of the data, and tracking it, and recognizing a gesture point of hands, feet, body or the like of a corresponding user.

In accordance with a first aspect of the present invention, there is provided an apparatus for recognizing multi-user interactions, the apparatus including:

a pre-processing unit for receiving a single visible light image to perform pre-processing on the image;

a motion region detecting unit for detecting a motion region from the image to generate motion blob information of the detected motion region;

a skin region detecting unit for extracting information on a skin color region from the image to generate a skin blob list;

a Haar-like detecting unit for performing Haar-like face and eye detection by using only contrast information from the image;

a face tracking unit for recognizing a face of a user from the image by using the skin blob list and results of the Haar-like face and eye detection; and

a hand tracking unit for recognizing a hand region of the user from the image.

In accordance with a second aspect of the present invention, there is provided a method for recognizing multi-user interactions, the method including:

receiving a single visible light image to perform pre-processing on the image;

generating a skin blob list for a skin color region from the image;

performing Haar-like face and eye detection by using only contrast information from the image;

tracking a face of a user from the image by using the skin blob list and results of the Haar-like face and eye detection to generate a user face list for the tracked face;

recognizing a hand region of the user from the image to generate a hand list; and

recognizing an event for each hand within the hand list.

### BRIEF DESCRIPTION OF THE DRAWINGS

The objects and features of the present invention will become apparent from the following description of embodiments, given in conjunction with the accompanying drawings, in which:

FIG. 1 is a block diagram showing a multi-user interaction recognition apparatus in accordance with an embodiment of the present invention;

FIGS. 2A and 2B are a flowchart showing signal processing of recognizing face, hands, and an event of a user in the multi-user interaction apparatus in accordance with the embodiment of the present invention;

FIGS. 3A and 3B are a flowchart showing signal processing of giving a user ID and performing tracking after recognizing a face in accordance with the embodiment of the present invention;

FIG. 4 is a table illustrating the rules of giving a user ID and performing tracking in accordance with the embodiment of the present invention;

FIG. 5 is a flowchart showing separation of an individual face region and a hand region by blob overlapping separation in accordance with the embodiment of the present invention;

FIG. 6 is a flowchart showing signal processing of giving a hand ID and performing tracking in accordance with the embodiment of the present invention;

FIG. 7 is a flowchart showing extraction of a hand click event in accordance with the embodiment of the present invention; and

FIG. 8A is a view illustrating a result screen of recognition of a user face and hand gestures in accordance with the embodiment of the present invention.

FIG. 8B shows an example of multi-touch interaction of multi-users.

### DETAILED DESCRIPTION OF THE EMBODIMENTS

Hereinafter, embodiments of the present invention will be described with reference to the accompanying drawings which form a part hereof.

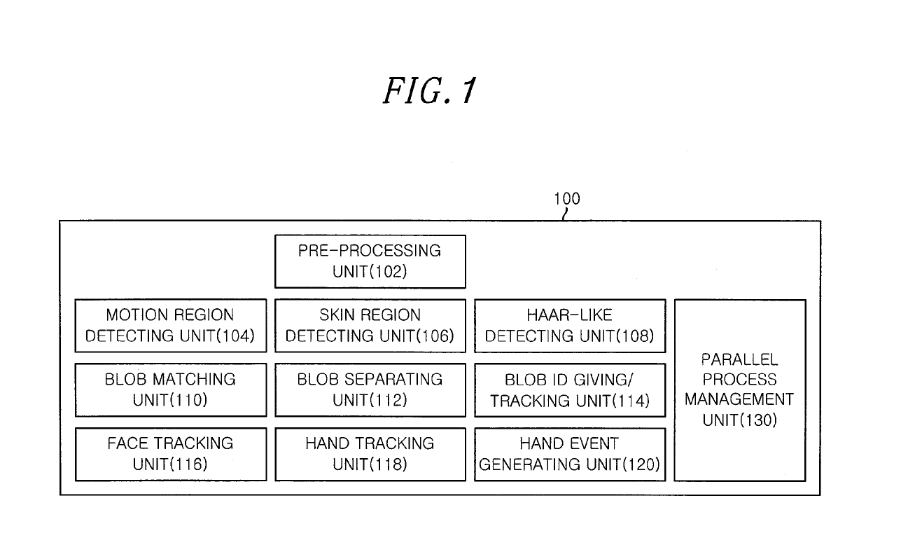

FIG. 1 shows a detailed block diagram of an apparatus for recognizing multi-user interactions by using an asynchronous vision processing in accordance with an embodiment of the present invention. The apparatus 100 for recognizing multi-user interactions includes a pre-processing unit 102, a motion region detecting unit 104, a skin region detecting unit 106, a Haar-like detecting unit 108, a blob matching unit 110, a blob separating unit 112, a blob identification (ID) giving/tracking unit 114, a face tracking unit 116, a hand tracking unit 118, a hand event generating unit 120, and a parallel process management unit 130.

The operation of each component of the apparatus 100 will be described in detail with reference to FIG. 1.

First, the pre-processing unit 102 receives a single visible light image and performs pre-processing on the image. Specifically, the pre-processing unit 102 uniformalizes different white balance, contrast, brightness, color distribution, and the like of each image frame such that equal results can be obtained through later image processing.

The motion region detecting unit 104 detects motion regions from the received visible light image to generate motion blob information including pixel information, contour information and the like of the detected motion regions.

The skin region detecting unit 106 extracts information on skin color regions from the image. The extracted information on the skin color regions is separated into respective distinct blobs to generate a skin color blob list together with contour information or the like.

When data of both the motion blob information and the skin color blob list are generated, the skin region detecting unit 106 finds a real skin region of a moving human based on the both data. In general user's environment, the same color as or a similar color to skin color of human may appear a lot on the background of the user. However, the skin color on the background does not have the motion blob information as long as a camera does not move, and only blobs of a real human have the motion blob information during an entire observation. The skin region detecting unit 106 separates a portion considered as a real skin region of a human from the skin color regions observed in a current image based on this observation to generate a skin blob list.

The Haar-like detecting unit 108 performs Haar-like face and eye detection by using only contrast information of the image to generate a Haar-like face detection result and a Haar-like eye detection result.

The blob matching unit 110 matches two or more blob lists to each other.

The blob separating unit 112 performs a blob separation by a clustering technique when blobs that have been separated in a previous image frame are overlapped in a current image frame.

The blob ID giving/tracking unit 114 tracks and manages all blobs appearing in every image frame.

The face tracking unit 116 recognizes a user face by taking a previous user face list, together with the skin blob list information estimated in the current image frame, the Haar-like face detection result and the Haar-like eye detection result, as inputs, and gives an ID to the user face to perform face tracking.

The hand tracking unit 118 recognizes hand regions of the user from the image and provides each user with a hand blob list for the hand regions based on the user face list and performs hand tracking. First, the hand tracking unit 118 generates an updatable hand blob list having more than a predetermined amount of motion points among the hand blob list. That is, the hand tracking unit 118 recognizes only a hand region with sufficient movement as a human hand from the hand blob list and sets the hand region as a target for updating real gesture information.

The hand event generating unit 120 checks a shape of a hand, i.e., whether it is opened or closed in order to check an event in the hand region. The event regarding a hand is measured based on a fact that region information is significantly varied when a hand is opened or closed.

The parallel process management unit 130 parallelizes the entire process of recognizing face, hands, and an event of a user for their management, manages a result value obtained from each process, and enables pipelining of each process.

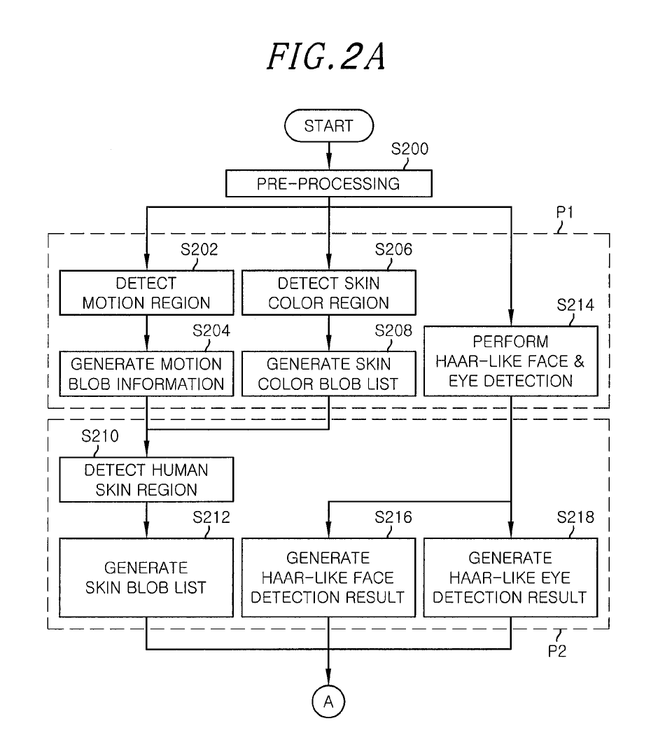

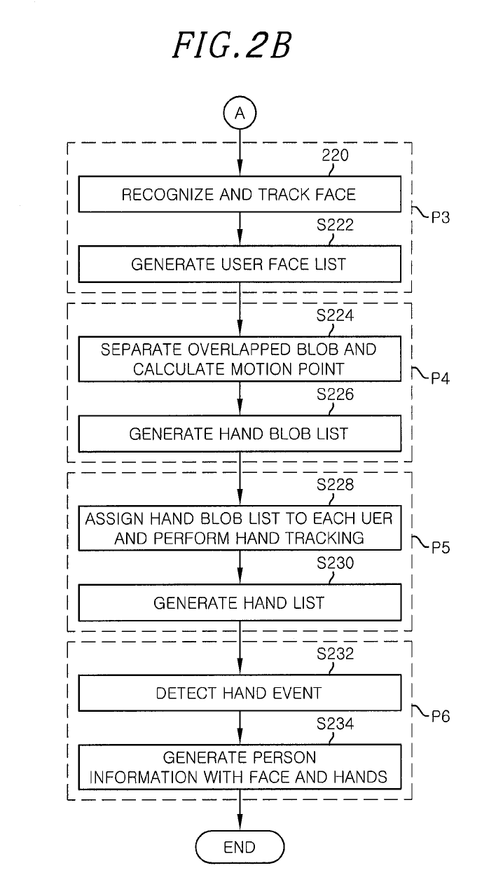

FIGS. 2A and 2B are a flowchart showing an entire process of recognizing face, hands, an event of a user in the apparatus 100 for recognizing multi-user interactions shown in FIG. 1. Hereinafter, the embodiment of the present invention will be described in detail with reference to FIGS. 1 to 2B.

First, the pre-processing unit 102 receives a single visible light image and performs pre-processing on the image in step S200. During the pre-processing, different white balance, contrast, brightness, color distribution and the like of each image are uniformalized such that equal results can be obtained through later image processing.

Next, in procedures P1 and P2, basic image processings or recognition algorithms that can be performed in parallel are performed independently and simultaneously.

In detail, the motion region detecting unit 104 detects motion regions from the pre-processed visible light image in step S202 and generates motion blob information including pixel information, contour information and the like of the detected motion regions in step S204. At the same time, the skin region detecting unit 106 extracts information of skin color regions by using various methods in step S206. The extracted skin color region information is separated into respective distinct blobs to generate a skin color blob list including contour information or the like in step S208.

As such, when two data, i.e., both the motion blob information and the skin color blob list are generated, a real skin region of a human who is moving is found based on these data. Specifically, the skin region detecting unit 106 separates a portion considered as a real skin region of a human from the skin color regions observed in a current image in step S210 to generate the skin blob list in step S212.

Meanwhile, in step S214, which is performed independently from and simultaneously with the above steps, the Haar-like detecting unit 108 performs Haar-like face and eye detection by using only contrast information of the image to generate a Haar-like face detection result in step S216 and a Haar-like eye detection result in step S218.

In this case, the Haar-like face and eye detection may be applied to various images because it uses only relative contrast information in the images, but only detects a user in a specific position, e.g., only detects a full-face or a side face of the user based on a search data tree used. That is, if a used search data set is related to a full-face, a face is recognized only when the user reveals his/her full-face. Due to this, since the user's face region is intermittently detected in a general moving image even though any search data set is used, it is difficult in above step S214 to effectively detect the user's face, give an ID and track it. In order to overcome this limitation, the present invention gives a user ID through various additional image information and complex procedures and then enables the tracking.

As such, after procedures P1 and P2 are completed, a face tracking procedure P3 is performed.

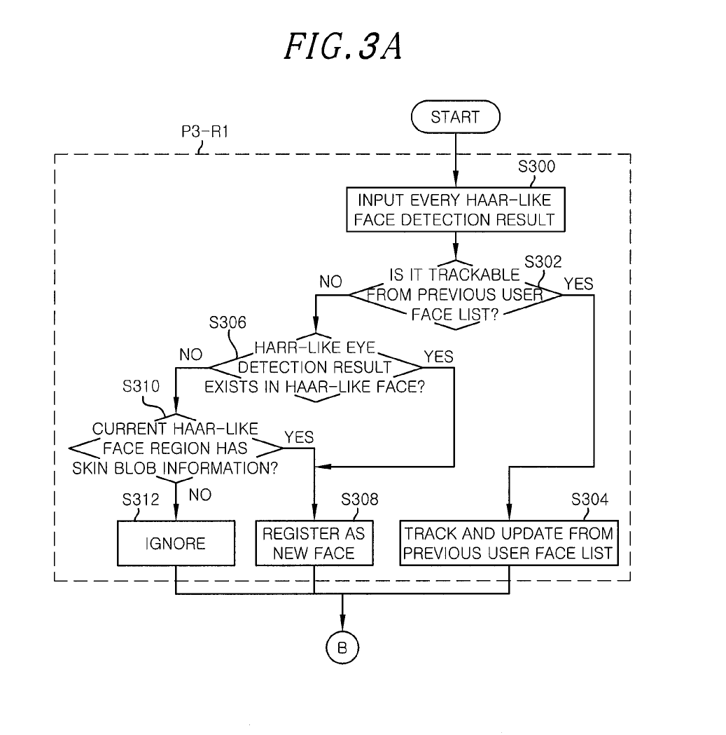

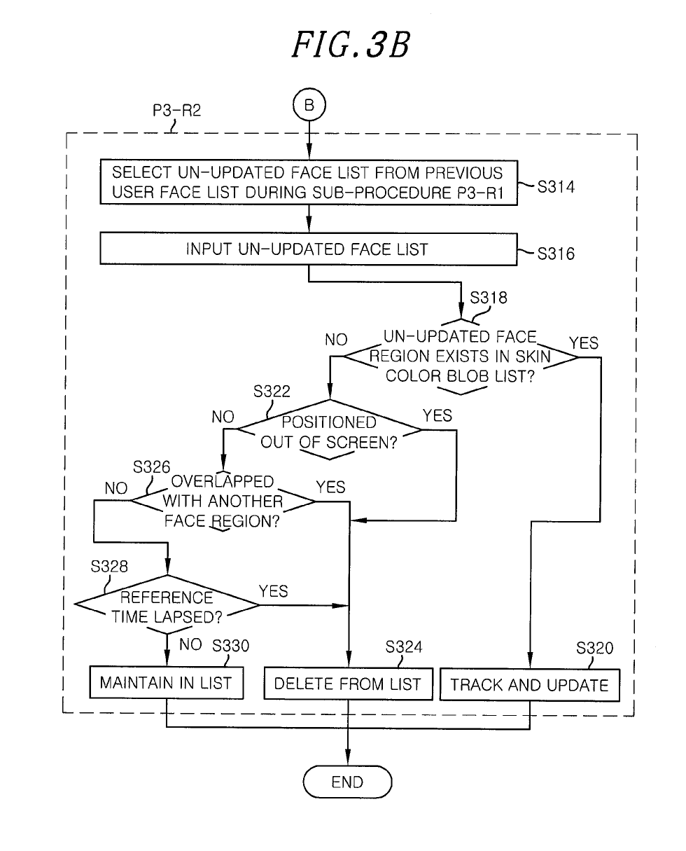

In the procedure P3, the face tracking unit 116 detects the user face based on a previous user face list along with the skin blob list observed in the current image (current image frame), the Haar-like face detection result and the Haar-like eye detection result in step S220. Further in the same step S220, the face tracking unit 116 gives an ID to the detected user face and tracks the same. Thereafter, in step S222, a current user face list is generated. In order to give and maintain the user ID during the tracking, the procedure P3 is performed by being divided into sub-procedures P3-R1 and P3-R2 as shown in FIGS. 3A and 3B.

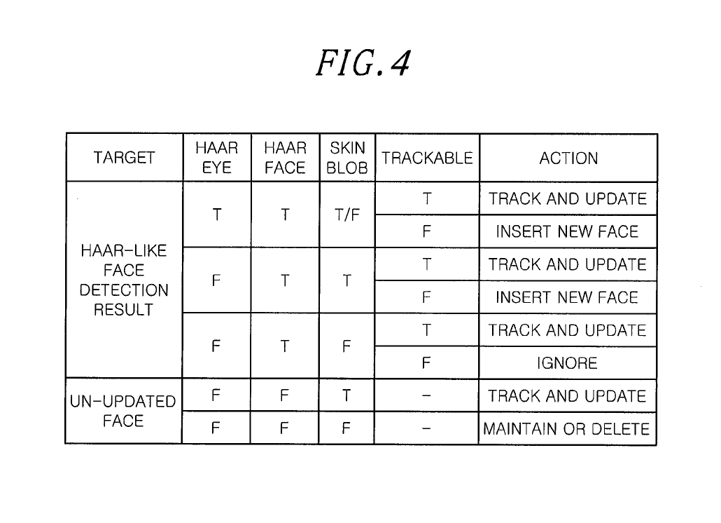

Referring to FIGS. 3A and 3B, in the first sub-procedure P3-R1, the tracking starts based on a list expected as a current face due to the Haar-like face detection result. In this tracking, as shown in FIG. 4, it is determined whether Haar-like eye is detected, whether a corresponding region is a skin color region, and whether the corresponding region is similar or close to a previous face region which has been given an ID and being tracked, in respective pixel regions of every Haar-like face detection result. Then, based on the determination results, (1) corresponding information is given an ID and added to the list as a new face list, (2) previous data is updated by tracking in the previous user face list, or (3) wrong recognition is ignored.

In more detail, every Haar-like face detection result is inputted in step S300 and it is checked for each Haar-like face whether tracking is possible from the previous user face list, i.e., whether a Haar-like face is trackable from the previous user face list in step S302. If possible in step S302, continuous tracking from the previous user face list and update of the previous user face list are performed in step S304.

If not possible in step S302, it is checked whether the Haar-like eye detection result exists in the Haar-like face in step S306. At this time, if one or more Haar-like eye is detected in the Haar-like face, a corresponding region may be surely considered as a face. In this case, the corresponding region is determined as a face regardless of whether the corresponding region is a skin region. If there previously exists a face to which an ID has been given in the corresponding region or a close region thereto, the face to which the ID has been given is used to update a current Haar-like user face list. If there is no information indicating that it has been previously recognized, the corresponding region is recognized as a new face region and added to the face list by giving an ID to the corresponding region in step S308.

If no Haar-like eye is detected in the Haar-like face in step S306, it is checked whether a corresponding region has skin blob information in step S310 to determine whether the corresponding region is a real face region.

When the corresponding region has the skin blob information, like the previous procedure, the previous user face list is checked to update the current Haar-like user face list or to newly add the corresponding region as a new face region in step S308. When the corresponding region does not have the skin blob information in step S310, the previous user face list is checked. When there previously exists face information related to the corresponding region in the previous user face list, update is performed. Whereas, when there is no face information related to the corresponding region in the previous user face list, the current Haar-like face recognition is considered as erroneous detection and ignored in step S312.

As described above, when the execution of the first tracking sub-procedure P3-R1 based on the Haar-like face detection result is completed, the second tracking sub-procedure P3-R2 is performed. First, a face list that is not updated during the sub-procedure P3-R1 is selected in the previous user face list in step S314, and the un-updated face information is inputted in step S316.

In the second sub-procedure P3-R2, the tracking and update are performed through only the skin blob information, as shown in FIG. 4. If the skin blob information is not generated in a current region, they are determined in combination whether the corresponding region is positioned out of a screen, whether it is overlapped with another face in the current user face list, and whether update is not performed for a long time and then based on the determination results, the corresponding region may be maintained in the current user face list as it is or it may be deleted.

Thereafter, as for the un-updated face information, it is checked whether each of the un-updated face regions exists in a current skin color blob list related to a corresponding face region in step S318. If so, the previous face region information is updated with corresponding blob information in step S320.

If each of the un-updated face regions does not exist in the current skin color blob list in step S318, it is first checked whether the corresponding region is positioned out of the screen in step S322. If it is checked to be out of the screen, it is considered that the corresponding user is out of the screen and the corresponding user's face information is deleted from the current user face list in step S324.

Alternatively, if it is checked in step S322 that the corresponding region is positioned within the screen, it is further checked whether the corresponding region is overlapped with another user face in a currently recognized face list in step S326. If overlapped, the corresponding user is determined to be at the back of another user and the corresponding user's face information is deleted from the current user face list in step S324.

Regarding face information which is not deleted and still remains in the current user face list from the above steps, it is checked whether a preset reference time has been lapsed in step S328. If not, the face information is maintained in the current user face list for a predetermined period in step S330. If the reference time has been lapsed and the update has not been performed for a long time, the face information is also deleted from the current user face list in step S324.

As such, when the current list of the user faces to which an ID has been given is generated in step S222 through the procedure P3, a hand blob considered as a user hand is extracted together with the skin information in a procedure P4 shown in FIG. 2B. Here, a user skin region may be overlapped with another skin region anytime (e.g., when a hand is overlapped with another hand, a hand touches face, or the like), and in this case, the user skin region is separated based on a clustering technique considering movements over time in step S224. Further, a motion point of the skin region is calculated in the same step S224, and a current hand blob list is generated in step S226.

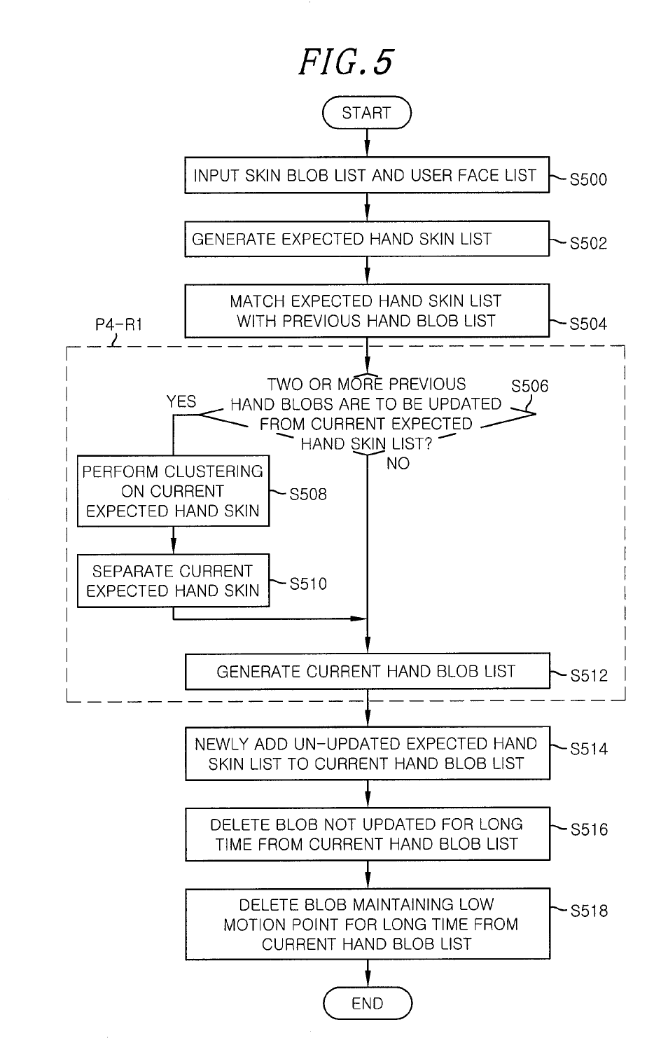

Hereinafter, the procedure P4 will be described in detail with reference to FIG. 5 which shows a flowchart of signal processing. First, a skin blob list and the current user face list are inputted in step S500. In order to find a skin region to be assumed as a human hand, an expected hand skin list is generated by excluding blobs corresponding to the face region, which has been obtained as a result of the previous procedure P3, from the skin blob list in step S502.

Next, the expected hand skin list is matched up with the previous hand blob list as hand tracking information in a previous frame to generate a mutually updatable mapping table in step S504. Then, during a sub-procedure P4-R1 as a repetitive routine, regarding each of the expected hand skin list, it is checked whether there is a previous hand blob list to be updated from the expected hand skin list based on the mapping table. At this time, when two or more hands are simultaneously to be updated from one expected hand skin list in step S506, it is determined that previously separated hand blobs are overlapped now and the clustering technique is performed in step S508 to separate a corresponding region in step S510. A learning value during the clustering becomes the two or more previous hand blobs and the separation target value becomes a current expected hand skin with which the two previous hand blobs are updated.

The thus separated expected hand skins generate a current hand blob list by updating the previous hand blobs in step S512. In addition, the current expected hand skin that cannot be associated with the previous hand blobs are newly added to the current hand blob list in step S514. During this step, those that are not updated now in the previous hand blobs are maintained in the current hand blob list for now but those that have not been updated for a long time are deleted in step S516.

Also, during the update of the hand blobs, displacement values of movements of a corresponding region are accumulated and recorded, and these are called motion points. Based on the motion points, it is determined whether a corresponding region is an actually moving human hand. When the corresponding hand region has a very low motion point for a long time, this is also excluded from the current hand blob list in step S518.

Next, in a procedure P5 shown in FIG. 2B, The hand tracking unit 118 assigns the above current hand blob list to each user based on the current user face list and performs hand tracking in step S228 to thereby generate a hand list in step S230.

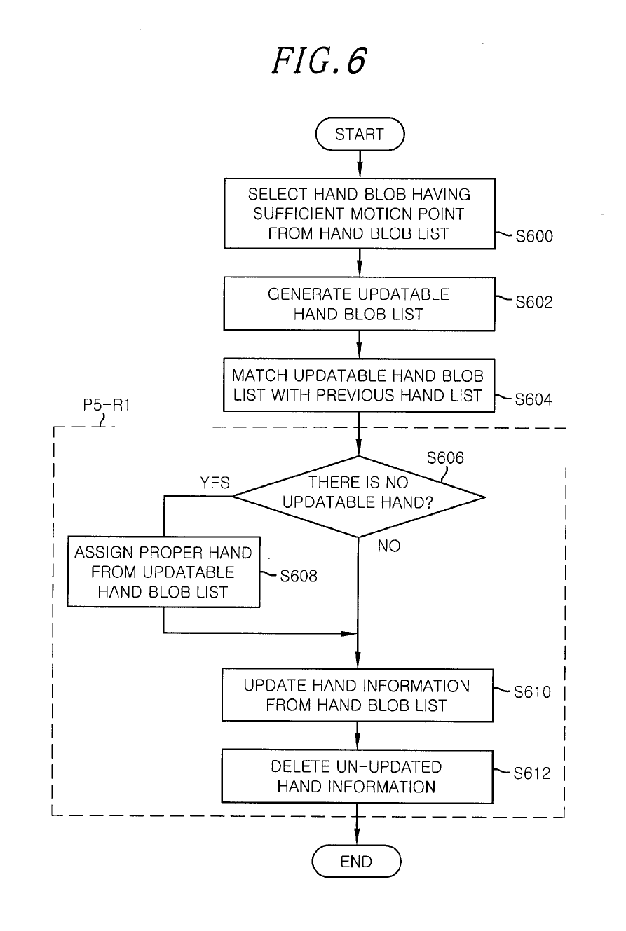

Hereinafter, the procedure P5 will be described in detail with reference to FIG. 6. First, hand blobs having more than a predetermined amount of motion points are selected from the hand blob list in step S600 to generate an updatable hand blob list in step S602. That is, only a hand region having sufficient movement in the hand blob list is recognized as a human hand and is taken as an actual update target of gesture information.

Then, the updatable hand blob list is matched with a previous hand list resulting from a previous frame to generate an updatable mapping table in step S604.

Thereafter, in a sub-procedure P5-R1 as a repetitive routine, it is checked whether there is an updatable hand in the current updatable hand blob list for each person in step S606. If there is an updatable pair in the mapping table, current human hand information is updated based on the updatable pair in step S610.

If there is no updatable pair in the mapping table, which is a case that a current person has not been assigned any hand information, a rank-rule is applied to hands that are not in the mapping table but in a predetermined hand distance region in proportional to a current face size from the current updatable hand blob list to assign corresponding hands as the current human hand information in step S608. Through the above step, a current human hand that is not updated is determined to be screened by other object now and thus deleted from the current human hand information in step S612.

As described above, through the procedures P1 to P5, a human face is detected, given an ID, and tracked, and then hand information of a corresponding person is tracked. Subsequently, a procedure P6 shown in FIG. 2B is performed.

In the procedure P6, the hand event generating unit 120 checks a shape of a hand, i.e., whether it is opened or closed, in order to detect an event in a hand gesture region in step S232 to thereby generate person information with face and hands in step S234. The event regarding a hand is measured based on a fact that region information is significantly varied when a hand is opened or closed.

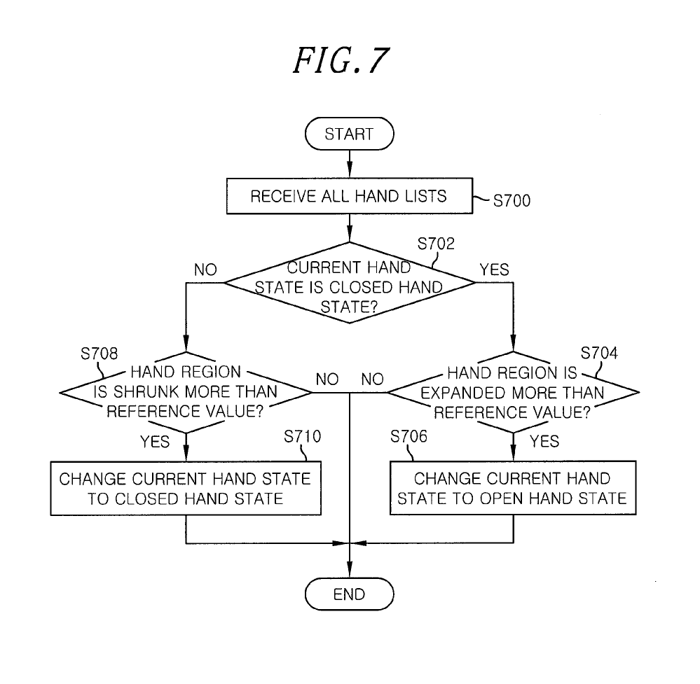

In more detail, referring to FIG. 7 showing a detailed flow of the procedure P6, all the hand lists generated in the procedure P5 are received in step S700. Then, in step S702, it is checked whether a current hand's state is a closed hand state in the hand region information of each person.

At this time, information regarding whether the hand is closed or opened in a corresponding hand region is a value calculated in the previous frame. In a case where a previous state is a closed hand state, if the corresponding hand region has been remarkably expanded more than a predetermined reference value, differently from the previous state in step S704, it is determined that the state of the corresponding hand region has been shifted from the closed hand state to an open hand state in step S706.

However, in a case where the previous state is an open state, if the corresponding hand region has been remarkably shrunk more than a predetermined reference value, differently from the previous state in step S708, it is determined that the state of the corresponding hand region has been shifted from the open hand state to the closed hand state in step S710.

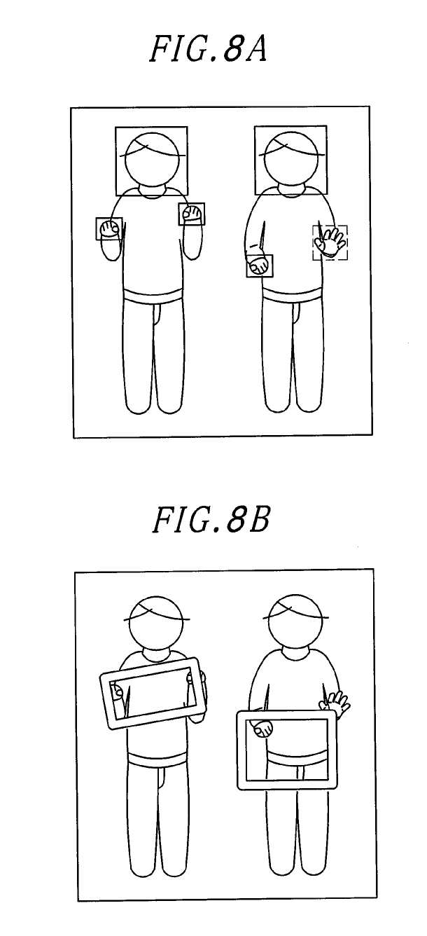

FIG. 8A shows a result screen of recognition of a user face and hand gestures.

Referring to FIG. 8A, a user face is detected and an ID is given thereto. Also, hand gestures of a user are detected, wherein a closed hand is detected by a rectangle of a continuous line and an open hand is detected by a rectangle of a broken line. This hand gesture information of the respective users who have been given IDs is applied to various systems so that intuitive user interaction can be provided. As one example, FIG. 8B shows multi-touch interaction of multi-users. In FIG. 8B, the open hand and the closed hand is recognized as mouse button up and down, respectively, so that respective individual rectangular objects can be moved, rotated, enlarged, and reduced.

As described above, in an apparatus and method for recognizing multi-user interactions by using an asynchronous vision processing, data is simultaneously produced from a single webcam image through various types of vision processes, faces of multi-users are effectively detected through complex relation setting of the data and multiple computing on the data, the detected user is given an ID and tracked, and a gesture point such as a hand, a foot, a body of the detected user is also recognized, so that multi-users can be exactly recognized even in a single visible light image.

Further, a low resolution image inputted from a cheap webcam as well as a single image is supported, so that, even in a single visible light image, multiple users can be recognized in real time without any additional equipment and environment to extract a gesture event of a corresponding user. Also, in general home environment, a user can interact directly with a TV, or a user can provide an enough space interaction in a mixed augmented reality space.

While the invention has been shown and described with respect to the embodiments, it will be understood by those skilled in the art that various changes and modification may be made without departing from the scope of the invention as defined in the following claims.

What is claimed is:

1. An apparatus for recognizing multi-user interactions, the apparatus comprising:
a pre-processing unit for receiving a single visible light image to perform pre-processing on the image;
a motion region detecting unit for detecting a motion region from the image to generate motion blob information of the detected motion region;
a skin region detecting unit for extracting information on a skin color region from the image to generate a skin blob list;
a Haar-like detecting unit for performing Haar-like face and eye detection by using only contrast information from the image;
a face tracking unit for recognizing a face of a user from the image by using the skin blob list and results of the Haar-like face and eye detection; and
a hand tracking unit for recognizing a hand region of the user from the image.

2. The apparatus of claim 1, further comprising:
a hand event generating unit for checking a motion event of a hand in the hand region.

3. The apparatus of claim 1, wherein the pre-processing unit uniformalizes different white balance, contrast, brightness and color distribution of each image frame in the image.

4. The apparatus of claim 1, wherein the motion blob information includes pixel information and contour information of the motion region.

5. The apparatus of claim 1, wherein the skin region detecting unit separates the extracted information on the skin color region into respective distinct blobs to generate a skin color blob list together with contour information.

6. The apparatus of claim 5, wherein the skin region detecting unit finds, when data of both the motion blob information and the skin color blob list are generated, a real skin region of a moving human based on the both data.

7. The apparatus of claim 1, wherein the face tracking unit gives an ID to each face recognized from the image to perform face tracking.

8. The apparatus of claim 1, wherein the hand tracking unit checks a motion of each hand in a hand blob list for the hand region recognized from the image to recognize a hand region having the motion larger than a predetermined reference value as a human hand.

9. A method for recognizing multi-user interactions, the method comprising:
receiving a single visible light image to perform pre-processing on the image;
generating a skin blob list for a skin color region from the image;
performing Haar-like face and eye detection by using only contrast information from the image;
tracking a face of a user from the image by using the skin blob list and results of the Haar-like face and eye detection to generate a user face list for the tracked face;
recognizing a hand region of the user from the image to generate a hand list; and
recognizing an event for each hand within the hand list.

10. The method of claim 9, wherein said generating the skin blob list includes:
detecting a motion region from the image to generate motion blob information of the detected motion region;
detecting a skin color region from the image to generate a skin color blob list;
detecting a real skin region of a human from the image by using the motion blob information and the skin color blob list; and
generating the skin blob list for the detected real skin region.

11. The method of claim 9, wherein said recognizing the hand region includes:
recognizing the hand region from the image;
generating a hand blob list for the recognized hand region;
checking a motion of each hand in the hand blob list to recognize a hand region having the motion larger than a predetermined reference value as a human hand; and
generating the hand list by using information regarding the recognized human hand.

12. The method of claim 9, wherein different white balance, contrast, brightness and color distribution of each image frame in the image are uniformalized during the pre-processing.

13. The method of claim 9, wherein the motion blob information includes pixel information and contour information of the motion region.

14. The method of claim 9, wherein, in said tracking the face of the user, a different ID is given to each face recognized from the image.
